(19) United States
(12) Patent Application Publication
(10) Pub. No.: US 2024/0281881 A1
(43) Pub. Date: Aug. 22, 2024

(54) COMPOSABILITY AND EFFICIENCY IMPROVEMENTS IN DECENTRALIZED MARKETS

(71) Applicant: Robo Inc., Wantage, Oxfordshire (GB)

(72) Inventors: Matthew John Foster WILLETTS, London (GB); Toby St Clere SMITHE, Glasgow (GB)

(21) Appl. No.: 18/581,704

(22) Filed: Feb. 20, 2024

Related U.S. Application Data
(60) Provisional application No. 63/447,240, filed on Feb. 21, 2023.

(51) Int. Cl. G06Q 40/04

(52) U.S. Cl. CPC G06Q 40/04

(57) ABSTRACT

Systems, methods, apparatuses, and computer program products for improving composability and efficiency in decentralized markets through composite pools, efficient estimators and non-linear techniques. One method may include calculating at least one entry of a weight vector according to at least one estimator-based rule to be applied to a liquidity pool, and based at least in part upon the calculated at least one entry of a previous weight vector, storing the at least one entry of the weight vector onto a blockchain configured to determine whether to perform an exchange of at least one asset for at least one other asset from among a pre-defined pool of other assets.

### CROSS-REFERENCE TO RELATED APPLICATION

This application claims the benefit of U.S. Provisional Patent Application No. 63/447,240, filed Feb. 21, 2023, which is herein incorporated by reference in its entirety.

### TECHNICAL FIELD

Some example embodiments may generally relate to an automated liquidity provider (LP) integrated with one or more computer-based blockchains to adjust trading functions of an automated market maker (AMM) pool over time. In particular, various example embodiments may be directed towards dynamic decentralized market making and portfolio construction to improve energy efficiency, reduce slippage, and improve composability.

### BACKGROUND

First generation AMMs instantiate an extremely limited and fixed strategy: a simple holding strategy very often provides superior returns compared to depositing into a constant-function market maker (CFMM). Challenges remain, including that described as “loss versus rebalancing,” and LPs are seeking new ways to expand liquidity and limit order books while simultaneously reducing consumption of energy and computing resources, and running costs. A fixed-weight strategy is one disadvantage of AMMs, and altering the strategies applied is one technique to improve the performance of AMMs.

### SUMMARY

In accordance with some example embodiments, a method may include calculating, by a computing device, at least one entry of a weight vector according to at least one estimator-based rule to be applied to a liquidity pool. The method may further include based at least in part upon the calculated at least one entry of a previous weight vector, storing, by the computing device, the at least one entry of the weight vector onto a blockchain configured to determine whether to perform an exchange of at least one asset for at least one other asset from among a pre-defined pool of other assets.

In accordance with certain example embodiments, an apparatus may include means for calculating at least one entry of a weight vector according to at least one estimator-based rule to be applied to a liquidity pool. The apparatus may further include means for based at least in part upon the calculated at least one entry of a previous weight vector, storing the at least one entry of the weight vector onto a blockchain configured to determine whether to perform an exchange of at least one asset for at least one other asset from among a pre-defined pool of other assets.

In accordance with various example embodiments, a non-transitory computer readable medium may include program instructions that, when executed by an apparatus, cause the apparatus to perform at least a method. The method may include calculating at least one entry of a weight vector according to at least one estimator-based rule to be applied to a liquidity pool. The method may further include, based at least in part upon the calculated at least one entry of a previous weight vector, storing the at least one entry of the weight vector onto a blockchain configured to determine whether to perform an exchange of at least one asset for at least one other asset from among a pre-defined pool of other assets.

In accordance with some example embodiments, a computer program product may perform a method. The method may include calculating at least one entry of a weight vector according to at least one estimator-based rule to be applied to a liquidity pool. The method may further include, based at least in part upon the calculated at least one entry of a previous weight vector, storing the at least one entry of the weight vector onto a blockchain configured to determine whether to perform an exchange of at least one asset for at least one other asset from among a pre-defined pool of other assets.

In accordance with certain example embodiments, an apparatus may include at least one processor and at least one memory storing instructions that, when executed by the at least one processor, cause the apparatus at least to calculate at least one entry of a weight vector according to at least one estimator-based rule to be applied to a liquidity pool. The at least one memory and instructions, when executed by the at least one processor, may further cause the apparatus at least to, based at least in part upon the calculated at least one entry of a previous weight vector, store the at least one entry of the weight vector onto a blockchain configured to determine whether to perform an exchange of at least one asset for at least one other asset from among a pre-defined pool of other assets.

In accordance with various example embodiments, an apparatus may include calculating circuitry configured to perform calculate at least one entry of a weight vector according to at least one estimator-based rule to be applied to a liquidity pool. The apparatus may further include storing circuitry configured to perform, based at least in part upon the calculated at least one entry of a previous weight vector, storing the at least one entry of the weight vector onto a blockchain configured to determine whether to perform an exchange of at least one asset for at least one other asset from among a pre-defined pool of other assets.

In accordance with some example embodiments, a method may include calculating, by a computing device, at least one entry of a weight vector according to at least one estimator-based rule. The method may further include applying, by a computing device, at least one maximal extractable value (MEV) protection to a value of the at least one entry of the weight vector. The method may further include storing, by a computing device, at least one entry of a weight vector configured to be applied to a particular liquidity pool.

In accordance with certain example embodiments, an apparatus may include means for calculating at least one entry of a weight vector according to at least one estimator-based rule. The apparatus may further include means for applying at least one maximal extractable value (MEV) protection to a value of the at least one entry of the weight vector. The apparatus may further include means for storing at least one entry of a weight vector configured to be applied to a particular liquidity pool.

In accordance with various example embodiments, a non-transitory computer readable medium may include program instructions that, when executed by an apparatus, cause the apparatus to perform at least a method. The method may include calculating at least one entry of a weight vector according to at least one estimator-based rule. The method may further include applying at least one maximal extractable value (MEV) protection to a value of the at least one entry of the weight vector. The method may further include storing at least one entry of a weight vector configured to be applied to a particular liquidity pool.

In accordance with some example embodiments, a computer program product may perform a method. The method may include calculating at least one entry of a weight vector according to at least one estimator-based rule. The method may further include applying at least one maximal extractable value (MEV) protection to a value of the at least one entry of the weight vector. The method may further include storing at least one entry of a weight vector configured to be applied to a particular liquidity pool.

In accordance with certain example embodiments, an apparatus may include at least one processor and at least one memory storing instructions that, when executed by the at least one processor, cause the apparatus at least to calculate at least one entry of a weight vector according to at least one estimator-based rule. The at least one memory and instructions, when executed by the at least one processor, may further cause the apparatus at least to apply at least one maximal extractable value (MEV) protection to a value of the at least one entry of the weight vector. The at least one memory and instructions, when executed by the at least one processor, may further cause the apparatus at least to store at least one entry of a weight vector configured to be applied to a particular liquidity pool.

In accordance with various example embodiments, an apparatus may include calculating circuitry configured to perform calculating at least one entry of a weight vector according to at least one estimator-based rule. The apparatus may further include applying circuitry configured to perform applying at least one maximal extractable value (MEV) protection to a value of the at least one entry of the weight vector. The apparatus may further include storing circuitry configured to perform storing at least one entry of a weight vector configured to be applied to a particular liquidity pool.

In accordance with some example embodiments, a method may include calculating, by a computing device, at least one entry of the block-specific weight vector configured for a trading function for a given block index. The method may further include, in response to a withdrawal request if one is made, calculating, by a computing device, at least one withdrawal fee based upon a predefined fee structure. The method may further include updating, by the computing device, at least one reserve. The method may further include checking, by the computing device, for at least one invariant proportional and/or performing an invariant check. The method may further include checking, by the computing device, for at least one net change of pool reserves for at least one trades configured for maximum extract value protection. The method may further include checking, by the computing device, for at least one liquidity provider holding, whether the transaction comprises a withdrawal request or a deposit request as part of a composite pool trade comprising at least one of withdrawal, deposits, and trades of liquidity provider tokens as constituent steps. The method may further include, upon determining that all requirements are satisfied, committing, by the computing device, at least one transaction to the blockchain.

In accordance with certain example embodiments, an apparatus may include means for calculating at least one entry of the block-specific weight vector configured for a trading function for a given block index. The apparatus may further include means for, in response to a withdrawal request if one is made, calculating at least one withdrawal fee based upon a predefined fee structure. The apparatus may further include means for updating at least one reserve. The apparatus may further include means for checking for at least one invariant proportional and/or performing an invariant check. The apparatus may further include means for checking for at least one net change of pool reserves for at least one trades configured for maximum extract value protection. The apparatus may further include means for checking for at least one liquidity provider holding, whether the transaction comprises a withdrawal request or a deposit request as part of a composite pool trade comprising at least one of withdrawal, deposits, and trades of liquidity provider tokens as constituent steps. The apparatus may further include means for, upon determining that all requirements are satisfied, committing at least one transaction to the blockchain.

In accordance with various example embodiments, a non-transitory computer readable medium may include program instructions that, when executed by an apparatus, cause the apparatus to perform at least a method. The method may include calculating at least one entry of the block-specific weight vector configured for a trading function for a given block index. The method may further include, in response to a withdrawal request if one is made, calculating at least one withdrawal fee based upon a predefined fee structure. The method may further include updating at least one reserve. The method may further include checking for at least one invariant proportional and/or performing an invariant check. The method may further include checking for at least one net change of pool reserves for at least one trades configured for maximum extract value protection. The method may further include checking for at least one liquidity provider holding, whether the transaction comprises a withdrawal request or a deposit request as part of a composite pool trade comprising at least one of withdrawal, deposits, and trades of liquidity provider tokens as constituent steps. The method may further include, upon determining that all requirements are satisfied, committing at least one transaction to the blockchain.

In accordance with some example embodiments, a computer program product may perform a method. The method may include calculating at least one entry of the block-specific weight vector configured for a trading function for a given block index. The method may further include, in response to a withdrawal request if one is made, calculating at least one withdrawal fee based upon a predefined fee structure. The method may further include updating at least one reserve. The method may further include checking for at least one invariant proportional and/or performing an invariant check. The method may further include checking for at least one net change of pool reserves for at least one trades configured for maximum extract value protection. The method may further include checking for at least one liquidity provider holding, whether the transaction comprises a withdrawal request or a deposit request as part of a composite pool trade comprising at least one of withdrawal, deposits, and trades of liquidity provider tokens as constituent steps. The method may further include, upon determining that all requirements are satisfied, committing at least one transaction to the blockchain.

In accordance with certain example embodiments, an apparatus may include at least one processor and at least one memory storing instructions that, when executed by the at least one processor, cause the apparatus at least to. The at least one memory and instructions, when executed by the at least one processor, may further cause the apparatus at least to. The at least one memory and instructions, when executed by the at least one processor, may further cause the apparatus at least to. The at least one memory and instructions, when executed by the at least one processor, may further cause the apparatus at least to. The at least one memory and instructions, when executed by the at least one processor, may further cause the apparatus at least to. The at least one memory and instructions, when executed by the at least one processor, may further cause the apparatus at least to. The at least one memory and instructions, when executed by the at least one processor, may further cause the apparatus at least to.

In accordance with various example embodiments, an apparatus may include calculating circuitry configured to perform calculating at least one entry of the block-specific weight vector configured for a trading function for a given block index. The apparatus may further include calculating circuitry configured to perform, in response to a withdrawal request if one is made, calculating at least one withdrawal fee based upon a predefined fee structure. The apparatus may further include updating circuitry configured to perform updating at least one reserve. The apparatus may further include checking circuitry configured to perform checking for at least one invariant proportional and/or performing an invariant check. The apparatus may further include checking circuitry configured to perform checking for at least one net change of pool reserves for at least one trades configured for maximum extract value protection. The apparatus may further include checking circuitry configured to perform checking for at least one liquidity provider holding, whether the transaction comprises a withdrawal request or a deposit request as part of a composite pool trade comprising at least one of withdrawal, deposits, and trades of liquidity provider tokens as constituent steps. The apparatus may further include committing circuitry configured to perform, upon determining that all requirements are satisfied, committing at least one transaction to the blockchain.

### BRIEF DESCRIPTION OF THE DRAWINGS

For a proper understanding of example embodiments, reference should be made to the accompanying drawings, wherein:

FIG. 1 illustrates an example of impermanent loss in a pool as a function of change in price ratio from when capitalized;

FIGS. 2a-c illustrate some examples of weight interpolations;

FIGS. 3a-b illustrate some examples of linear interpolations;

FIG. 4 illustrates an example of a composite pool composed of two base pools;

FIG. 5 illustrates an example of a flow diagram of a method according to various example embodiments;

FIG. 6 illustrates an example of a flow diagram of another method according to various example embodiments; and

FIG. 7 illustrates an example of various network devices according to some example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for improving energy and efficiency in decentralized markets through composite pools is not intended to limit the scope of certain example embodiments, but is instead representative of selected example embodiments.

Decentralized finance (DeFi) infrastructure has recently begun to incorporate AMMs and decentralized exchanges (DEXs). AMMs and DEXs can enable LPs (i.e., depositors) to earn a return on their capital (i.e., liquidity), by enabling traders to exchange one token for another against that supplied liquidity. In exchange for providing liquidity, LPs may receive liquidity tokens that represent their share of the capital deposited into the asset pool. LPs receive trading fees proportional to their LP token holdings (e.g., via accumulation of fees inside a pool). While some of these systems may allow liquidity provisions according to a pair of tokens, other systems may use a basket system. However, one disadvantage of DEX pools (e.g., Uniswap V3 built upon the Ethereum blockchain) is “impermanent loss,” wherein LPs frequently lose value even after receiving their trading fees. One disadvantage of DeFi is that many pools and LP wallets have greater impermanent loss compared to fee income. In effect, DeFi pools run a fixed-allocation strategy, which cannot be profitable when implemented as a DEX due to impermanent loss. Although trading fees can theoretically make LPs whole, they frequently do not in practice, including for frequently-traded sets of tokens.

Certain example embodiments described herein may have various benefits and/or advantages to overcome the disadvantages described above. For example, certain example embodiments may improve energy and efficiency in decentralized markets through composite pools. Thus, certain example embodiments discussed below are directed to improvements in computer-related technology.

Non-fixed-allocation strategies may not necessarily experience impermanent loss. Certain example embodiments may modify CFMMs by developing a decentralized method of dynamically re-weighting reserves held using oracle signals and functions thereof, thereby increasing the available returns on deposited capital. This may be achieved by changing portfolio vectors within the computer-driven trading function of the pool, wherein new portfolio vectors may be dynamically computed by selected function of selected oracles, leading to improved performance by computer-managed markets. As a result, some example embodiments may tune and minimize the risk profile to an appropriate level for these LPs.

Since pools are designed to obtain an increased value from re-balancing between tokens as the market unfolds (rather than solely relying on trading fees), various example embodiments may provide a more comprehensive understanding of DEX operations.

Cryptocurrencies may be traded. However, due to their mathematical structure, such DEXs can negatively affect the capital of LPs following price fluctuations (i.e., impermanent loss). Although retaining initial capital may yield better results compared to depositing the capital with a DEX since trading fees paid to the LPs may not exceed impermanent loss, this places significant limitations on capital management.

In certain example embodiments, LPs can build asset pools that may dynamically update how they store their value, based at least in part on market information. As a result, LPs can avoid impermanent loss, improve returns in capital gains, and minimize trading fees. This may provide a truly decentralized process since the ability to control the dynamics of the pool must be within control of the liquidity process, and the mechanics and data are clearly defined by smart contracts without off-chain bottlenecks.

Some example embodiments address the challenges discussed above since other, non-fixed-allocation strategies may not suffer impermanent losses. Specifically, various example embodiments may improve CFMMs by developing a decentralized method of dynamically re-weighting held reserves using oracle signals and functions thereof, thereby increasing the available returns on deposited capital. This may be accomplished by adjusting portfolio vectors within the constant function of the pool, whereby the new portfolio vectors may be a selected function of selected oracles (i.e., a data feed on a blockchain). As an example, feed may refer to price feed.

LPs may achieve superior performance; however, no strategy is possible without risking capital. Various example embodiments may include computer-driven techniques for minimizing the risk profile to desired levels. Since LPs strive to obtain increased value by re-balancing between tokens as markets shift (rather than only on trading fees), lower fees can be charged, and a more comprehensive understanding of trading opportunities can be provided.

Furthermore, various example embodiments may further improve the efficiency and versatility of decentralized markets by introducing a composite pool, including a pool of pools through interaction with dynamic re-weighting of assets. Such composite pools may allow LPs to distribute liquidity across sub-pools, thereby building arbitrary combinations of existing pools, and dynamically re-weighting across them in response to market conditions. Liquidity may be distributed across sub-pools while exposing prices in only base assets to the markets, rather than through token representing the liquidity proportion. As a result, the LP's liquidity can be exposed to improve asset performance while remaining exposed across the particular bundles of assets of interest.

For LPs, various example embodiments may provide dynamic decentralized pools, which may provide on-chain, robo-advisor functionality for cryptocurrency, thereby offering the potential for improved capital growth through dynamic re-weighting, as well as a greater range of potential baskets of assets through composite pools. For traders, following the decrease in pool fragmentation and/or increase in liquidity, certain example embodiments may provide a more efficient electronic trading interchange.

Some example embodiments may include a protocol offering automated, on-chain, permission-less and non-custodial pools (i.e., DEX), providing the benefits of DeFi, including reliability since it may not rely on a centralize entity to manage capital; may verify the logic and structure of the pool strategy; and may provide constant access to the protocol.

Various example embodiments may provide certain additional advantages, including on-chain updating of the weights of a pool by using update rules that implement a chosen strategy based upon input oracle information (e.g., price data); calculating gradients, variances, and precisions (i.e., inverse co-variances) of oracle signals; automated mechanisms to reduce re-balancing operations while protecting against front running; dynamically combining pools using compositionality to generate composite pools that include a variety of tokens and/or strategies, giving LPs highly expressive pools to dynamically manage such pools; and providing permissionless construction of pools with predetermined update rules.

Uniswap v1/v2 is an example of a CFMM, wherein the value of a particular function of its reserves remains constant or grows under a proposed trade. For example, the constant function for Uniswap v1/v2 may include equation (1) in Appendix 2, wherein R₁ may indicate reserves held by a pool on the protocol of a first token (e.g., wETH), and R₂ may indicate an amount of reserves held by the pool of a second token (e.g., wBTC). Thus, if the system needs to perform a transaction with a Uniswap pool, in order to exchange one token for another, their proposed transaction may be accepted if the updated reserves of the pool (\tilde{R}₁\tilde{R}₁) after this proposed transaction still multiply to at least the same value as before, thus resulting in equation (2) in Appendix 2. For this reason, these pools may be known as ‘constant-product’ pools. This system may operate only on pairs of tokens, and the pool may ultimately hold half of its value in each token: an arbitrage opportunity may exist if not already the case. The requirement that trades preserve the above invariant may mean that the system is, in effect, quoting a price—and that price depends directly on the current pool reserves. If the system may hold too little of its value in one token (less than half), it may quote above-market prices to the market in order to buy more of that token. As a result, pools may hold an economically-defined (rather than merely numerical) balance of assets (i.e., 50/50), as explained in more detail below.

In various example embodiments, Balancer extends CFMMs may be extended by having an arbitrary number of tokens in a given basket, and by weighting these tokens in the trading function. For example, Balancer's trading function may be defined as provided in equation (3) of Appendix 2. In this example, a set of tokens τ, |τ|=N present in the pool and wᵢ may indicate the weighting given to each. R={Rᵢ} may be the N-vector of currently-held reserves of each token. The weights w={wᵢ} may control how much value is stored in each token. Like a constant-product pool, an arbitrage opportunity may exist if this is not the case.

Following from the mathematical form of the trading function, these pools may be known as geometric mean market makers (G3Ms). The pool may hold fractions wᵢ of value in each token as the trading function provides an arbitrage opportunity if the pool's reserves do not have this property. For example, if the weighting is uniform, wherein

$${w}_{i} = \frac{1}{N} ,$$

an equal amount of value may be stored in each token.

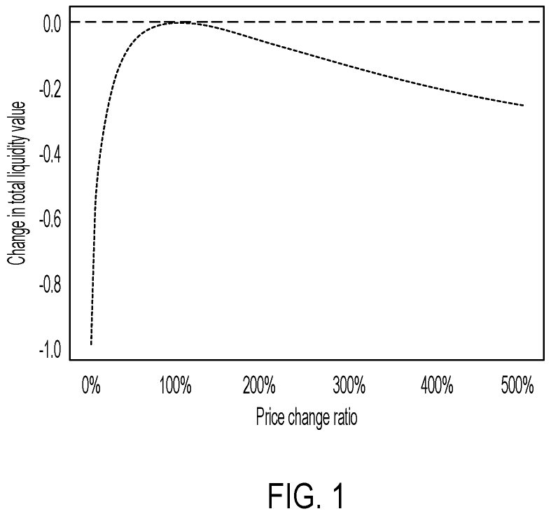

Applying a Balancer extension to multi-asset pools with chosen weights may reduce impermanent loss. Specifically, Balancer pools may have wᵢ and be larger or smaller than an agnostic 1/N. Having a smaller weight on a given token may cause relatively less impermanent loss, as a smaller proportion of the liquidity in the pool is allocated to that token. However, since the portfolio weights may sum to 1, this may result in a relatively greater risk of impermanent loss on at least one other token in the pool, as shown in FIG. 1.

One challenge with DEXes is impermanent loss (i.e., divergence loss) wherein prices may move away from those when a pool is deposited into by an LP leads to a loss of value for that LP. For example, in a DEX pool where one of the assets doubles in value, the pool's smart contract may offer trades to the market that lead to a reduction in the amount held of that token. Such offloading of the appreciating token occurs at a below-market price. As a result, the LPs (i.e., the depositors in the pool) do not benefit from the upwards trajectory of that doubled-in-value token as much as if they had merely held the assets. However, the providers of liquidity to DEXes would benefit from a protocol that attempts to manage their deposited capital in a way that depends on market dynamics, increasing and decreasing the size of its position with an aim to protect and grow capital.

However, these descriptions of impermanent loss may relate to AMM-specific situations. However, this is an example of a general principle that re-balancing has a cost to be compared to the performance of a strategy. Thus, all systems that reallocate capital over time, regardless of how they operate, have to pay some amount of value, at some frequency, to achieve their desired holdings over time. DEXes may have to pay some form of re-balancing cost, although not in the same way as a more traditional system that places trades on exchanges to re-balance.

DEXes may implement a strategy for LPs wherein the pool allocation is fixed. The pool may be continually re-balanced by the operation of arbitrageurs. Impermanent loss may merely be a combination of two facts: that the re-balancing cost to a DEX is guaranteed to be greater than the return their fixed-portfolio strategy can generate, and that these systems are sufficiently simple to be proven mathematically. However, if the portfolio weightings w change over time, then impermanent loss is no longer guaranteed; strategies other than fixed-w, implemented as a DEX pool, may have returns that outweigh their re-balancing cost.

In contrast with CFMMs, temporal-function market making (TFMM) may refer to trading functions of a pool that depends on time. In certain example embodiments, w, the portfolio vector, may be enabled to update on-chain using on-chain oracles, for example, the price of the tokens in the pool; thus, the allocation of assets in the pool may then be responsive to market information. Some example embodiments can circumvent impermanent loss. In order to indicate this new dependency of w on time, w(t) and the time-varying equation may be used to define a pool block-to-block (i.e., trading function) as provided in equation (4) of Appendix 2, where the time-dependence of k is explicit, as it now depends on the current, changing value of w(t). Within a block, weights may be constant (e.g., t may be the discrete blocknumber), and thus a known, clear value may be taken at a time that a trade occurs. Various example embodiments may provide a variety of techniques to construct various dynamic pools. A trade may still preserve (or increase) the value of k(t) that exists at the time of that trade. This may result in temporal-function market makers implemented by certain example embodiments. An automated TFMM pool thus may take a dynamic position, re-weighing its desired division of value between assets on the fly, doing so via offering arbitrage opportunities if its actual reserves are not in line with its actual reserves.

In order to change pool weights, update rules may be applied as possible functions to determine the changes in weights. However, update rules may need to improve capital performance, and may run on-chain for a given blockchain. Since any trade with a pool may not decrease k(t), the change in weights (i.e., re-weighting) may result in the pool's reserves to be re-balanced: trades that occur may bring the reserves closer to the target ratio, which may be expensive. If performed naively, the cost paid to arbitrageurs to rebalance may be prohibitively expensive; however, various forms of smoothing mechanisms may reduce cost.

Some automated pools may enable diverse portfolios and re-balancing strategies. For example, the architecture may enable LPs to avoid split management of multiple pools that each only contain a small basket of tokens. Through composite pools constructed by pooling pools, where the liquidity placed in a composite pool is distributed across its underlying pools, enabling an LP to benefit from the volume in these underlying pools while maintaining mathematical efficiency for re-balancing, allowing complex pools to be built-up and explored compositionally. This may be mathematically equivalent to a pool of LP tokens, but rebalancing and exposed prices may only be for base underlying assets, rather than LP tokens.

In addition, for some pools, composability may or may not lead to a change in strategy and performance of the resulting pools-of-pools compared to the initial base pools; a negative example is that a composite pool of CFMM pools may be another CFMM pool running the same strategy as the base pools, but over a larger basket of assets. A composite pool of TFMM pools may have new properties that no other subpool has.

Furthermore, composite pools may inherit pools' automatic re-weighting, wherein that liquidity may be shifted between base pools that are intended to perform better in different market conditions (e.g., between a bull market subpool and bear market subpool).

In some example embodiments, creating the mechanisms to have a DEX pool that may avoid impermanent loss via update rules, as well as having a larger diverse liquidity pools, may improve pool construction. However, confidence in the pool configurations and/or constant (e.g., automatic) management may be desired. However, a decentralized set of tooling may also require computing that is impractical on current blockchains. As used throughout this discussion, “liquidity pool” may refer to one or more collections of one or more digital assets/tokens that are provided by platform users, and may be managed by a smart contract to facilitate faster transactions.

When incorporated with partnerships that provide infrastructure, various example embodiments may offer a complete DEX including on-chain management tools. Such tooling may include, at least, standard update rule fact-sheets including market tests and quantitative analysis; historic and Monte Carolo value at risk (VaR) modelling (e.g., may be used in construction of a risk management update rule); retraining of update rule parameters given more recent market data or a breach of a configured condition (e.g., recent VaR exceeds limits); and/or compliance and regulation report generation.

Certain example embodiments may include strategies from traditional finance (TradFi) that may be implemented using various tools. For example, this protocol may provide the needed functionality to instantiate the pool's smart contract with a desired update rule. The provision of the tooling may be completely independent from the pool creator's choice of which rule to use and what tuning it should include. Furthermore, other community members may choose to capitalize this new pool or not, and if they become LPs, they may vote to tune or otherwise update the values of the parameters in the update rule. This may be in contrast to existing DEXes, wherein pools are instantiated by a choice of tokens along with some fixed or pre-defined function defining the weights w.

In various example embodiments, some or all update rules may contain numerical parameters that control their behavior, and these parameters may be preset. Choosing an uninformed parameter value may lead to negative performance of the pool. Alongside the smart contracts which implement various example embodiments, there may be a pool creation tool that provides contextual information and backtesting ability to allow pool creators to be more informed in their selection of parameter values for the target update equations (e.g., private alpha). On blockchains with cheaper computations (e.g., layer 2 (L2)), more sophisticated update equations may be possible, including calculations involving higher derivatives and special functions.

An important consideration is at what time these changes in weights should be applied, and may depend on the costs of calculations on a particular chain. In some blockchains, performing a re-weighting (e.g., querying some oracles, doing calculations) may occur at a cadence of hours or days, rather than seconds or minutes. Improved blockchains may provide faster cadence of weight calculations, which may be achievable with various example embodiments. It may be desirable to increase competition between pool creators, which may be divided between those that want to update rules and those that want to instantiate a particular pool with particular choices of parameters and tokens.

Knowing in isolation that a signal takes a particular value at the present moment is not necessarily useful for making a decision based on that signal. It is often by knowing how the current signal compares to previous values, on some chose timescale, that enables use of a signal. This may mean that desired update rules need a gradient operator to indicate how much a market signal has changed. The signals available may include those provided by oracles, thus some example embodiments may be capable of finding the gradients of oracles. In addition to providing useful, usable result, some example embodiments may be sufficiently computationally cheap that doing so may be performed on-chain.

Various example embodiments may calculate the gradient as “rise-over-run,” taking the difference between the value of an oracle and from a predefined time period. There may be excessive noise in a financial time series to perform this function; for example, a financial time series may not have a well-defined gradient that may be found as an infinitesimal rise-over-run calculation. These signals may not be viewed as being differentiable. Thus, there are often individual, erratic shifts in the market data, and it may not be desirable to over-fit changes in the pool to these transitory, rough movements. Some example embodiments may provide a smooth estimator of the oracle gradient, less impacted by very short term deviations. This may address problems of statistical estimation, wherein the effective temporal memory of the estimated gradient may be tuned.

In order to operationalize pool creators' desired update rules, a method is needed to calculate oracle gradients that is sufficiently and computationally efficient to be done on-chain. Some oracles may provide the prices of tokens (in a chosen format). Prices may be the information of prime importance. Thus, price oracles may become important, wherein provided oracles may be denoted as p(t), although this may be applied to any oracle (e.g., volume, volatility).

Some example embodiments may include a form of exponentially-weighted online least-squares regression to learn and update an estimate of at ∂p(t)/∂t, which may be denoted as β(t). That this is an exponentially-decaying estimator may mean that some example embodiments have a particular time-scale for the memory of price movements, allowing to more easily adapt to changes in market dynamics. With a decay parameter λ, the resulting update equations may be denoted by equations (5)-(7) in Appendix 2, wherein p̅(t) is a running exponentially-weighted moving average of the N tokens' prices, and aₜ is an intermediate state variable that is a constant ratio,

$$\frac{{( 1 - λ )}^{3}}{λ} ,$$

from the current estimate of the price gradient, β(t). The memory of this procedure may be

$${t}_{m e m} = \frac{{2}^{3} \sqrt{6 λ}}{( 1 - λ )} .$$

For example, with new price information each hour, this may result in λ=0.9 so that tₘₑₘ≈36 hours. These equations may assume that one single scalar λ may be used. If λ is promoted to a vector, λ (i.e., so each token may have its own memory length), one may use each token's λ for its own β(t) estimator.

In various example embodiments, a broad family of update rules may be in the form shown in equation (8) of Appendix 2, wherein p(t) is a vector giving the required oracles values, for example, the prices of the N tokens in the pool. ƒ may be chosen for a change in weights to be a function of p(t) and its time-derivative, giving a family of momentum-like (i.e., trend-following) strategies, such as provided in equation (9) of Appendix 2. Additional structure would yield equation (10) in Appendix 2, where k is a chosen parameter that tunes how quickly (i.e., how aggressively) the pool changes its weights in light of the signal it receives.

$$g ( p ( t ) , \frac{\partial p ( t )}{\partial t} )$$

may be the function that calculates that signal, derived from oracle and oracle-gradient values, that the rule uses. Scalar k may be provided by equation (11) in Appendix 2, such that the vector change in portfolio weights, w(t)−w(t−1), has entries that sum to 0. If the weights summed to one before this update, they may also sum to one after this update. In order to use these update rules with a gradient estimator, θp(t)/θt with β(t) may be defined using equations (5)-(7) in Appendix 2. It is noted that each token may have its own λ for its own estimator, rather than using the same λ for each token in a pool. As discussed in more detail below, simulation of rules that use the same λ for all tokens may be used, which may ease visualization of the results.

One type of pool to build using these techniques may include a standard momentum pool. Here, the weights may change in proportion to the gradient of prices, and in inverse proportion to the prices themselves. The result, at each w(t), may be denoted by equation (12) in Appendix 2. Division may be performed elementwise, and with equation (13) in Appendix 2.

Under anti-momentum updating, the weights may change in a negative proportion to the gradient of prices, and in inverse proportion to the prices themselves. So it may have the exact same governing equations as a standard momentum strategy, except with k→−k, as shown in equations (14) and (15) in Appendix 2.

lₚ₍ₜ₎ in the anti-momentum update rule, required to make the update sum to zero, may be related to mean-reversion strategies in TradFi that make use of the “winner-loser” effect. For a group of assets with observed similar behavior, one asset may lag the rest in its behavior temporarily before then “catching up.” This may provide an opportunity to build value, and for the right parameter choices, this rule may also provide returns during bear markets, as discussed later.

In some example embodiments, it may be desirable to have weights change in a non-linear way, rather than linearly. For example, it may be relatively insensitive to smaller changes in prices, but act particularly aggressively to larger changes. This may be related to the logic behind “channel” strategies in TradFi, wherein a portfolio changes its weights only if the asset prices “break-out” of a particular range around their trajectories. In such cases, there may be a cliff-edge trigger. In response, a smoother version may be applied, such as the “power channel” update rule provided in equation (16) of Appendix 2, wherein lₚ₍ₜ₎ is again chosen to make the update sum as zero, q₁, the exponent, is >1, and sets how strong this nonlinearity is.

In order to combine the properties of the above into one, for small price deviations, anti-momentum may apply where the trend is expected to revert; for larger deviations, a power-boosted momentum may apply where the trend is expected to continue. This may be accomplished with equation (17) in Appendix 2.

The above rules may not be exhaustive when implemented in example embodiments as a platform for permission-less structuring of automated pools. Users may compose custom update rules; for example, some example embodiments may choose to have equation (18) in Appendix 2, wherein A is a matrix, and b is a vector for which multiplication is done elementwise). Alternatively, they may choose some other function of w(t−1), p(t), and θp(t)/θt as the update rule for the pool they instantiate.

Some rules may commonly involve a step-size k, which may be more naturally parameterized not directly by k but by \tilde{k}.

$$\tilde{k} = \frac{k}{{t}_{m e m}} ,$$

where tₘₑₘ is the memory length of the estimator for the current rule. This may be a more natural parameterization as longer memory lengths (from larger λ values in equations (5)-(7) in Appendix 2) lead to smaller gradient estimators, so it may be reasonable for k to be parameterized taking this scaling into account.

Some update rules may need access to the variance of an oracle of the covariance between oracles. For example, any update rule that wants to use Markovitz/Mean-Variance Portfolio Theory (MVPT) or related techniques may apply them. The following is a discussion on how certain example embodiments may produce on-chain estimates of the covariance matrix for a set of oracles (e.g., oracles that quote prices), as well as separately the inverse of the covariance matrix, the precision matrix. Calculating the precision matrix as its own quantity makes sense, rather than obtaining it as the inverse of the covariance matrix since it may be undesirable to invert a matrix on-chain.

A set of mathematical methods may be used that are similar to those used to calculate a smoothed, exponentially-decaying estimator of the gradient of a signal to calculate these quantities. It may not require the covariance (nor precision) of raw signals (e.g., prices), but instead the covariance (or precision) of returns. Similar to the oracle gradient estimator, some example embodiments may use recent data points rather than old data points. In order to run this estimator cheaply on-chain, there may be an online estimator wherein new information is used to update a running estimate of the covariance/precision matrix. Following a substantially-similar derivation to that for the oracle gradient estimator, a covariance matrix for a set of oracles may be obtained by update equations (19)-(21) in Appendix 2, where division is performed elementwise, p̅(t) is a running exponentially-weighted moving average of the N oracles, A(t) is an intermediate state variable that is a constant ratio (1−λ) from the current estimate of the covariance matrix, Σ(t) and λ is the exponential weighting factor.

A Sherman-Morrison formula may be used to derive a similar on-line estimator for a precision matrix, thereby avoiding the need to perform a matrix inversion. The update equations may be provided by equations (22)-(24) in Appendix 2, where division is performed elementwise, p̅(t) is a running exponentially-weighted moving average of the N oracles being called, and S(t) is an intermediate state variable that is a constant ratio, (1−λ) from the current estimate of the precision matrix, Σ(t).

In some example embodiments, MVPT may be used to construct a broad array of different portfolios. The update rules that come from MVPT may differ to the other update rules considered so far: they may not have the form of equation (10) of Appendix 2. Rather, they may be examples of an update rule of the more general form of equation (8). This may be due to MVPT not providing a series of changes to portfolio weights but instead providing portfolio weight vectors directly.

In order to use update rules that naturally produce whole portfolio weight vectors rather than weight changes, exponential smoothing may be applied over the sequence of given weight vectors, as in equation (25) of Appendix 2, wherein A is an exponential smoothing parameter, which may be analogous to that used in oracle gradient/covariance calculations.

Various example embodiments may use MVPT outputs, such as the minimum variance portfolio. ŵ^{min-var}(t) may be the sequence of min-variance weights. For simplicity, assets may be modelled as uncorrelated with each other and having zero average return. Given these assumptions, the minimum-variance weights may be provided by equation (26) of Appendix 2, wherein Σ⁻¹(t) may be a vector whose elements are the precisions of the returns for each token in the pool, which may result in equation (27) of Appendix 2. The inverse-variance estimation process may have its own memory length, determined by λ above, which may be used to parameterize the pool alongside Λ.

All update rules may contain some parameters. For example, those parameters may have clear interpretations, thereby changing a pool's aggressiveness (k) or memory length (λ). In some examples, the parameters may have a less clear interpretation (e.g., b in equation (15) in Appendix 1). To deploy a pool, these parameters may need to be selected. For wide ranges of parameter values, the example update rules described herein may perform well, in a range of market conditions. However, particular values of the parameters of a pool's update rule must be given. Some example embodiments may provide to pool creators a pool-software development kit (SDK) that enables the design of pools, and the tuning of pool parameters in accordance with the creator's goals. This may maximize a Sharpe ratio over historical data, and/or minimize variance of returns over Monte Carlo draws of price movements, or any of a broad range of other objective functions. This may be achieved via backprogation (i.e., gradient descent, which can be applied even if the problem is non-convex).

The example update rules described above may produce pools that run a single mathematical formula based on some particular choices of parameters k (i.e., aggressiveness) and λ (i.e., memory). With these rules, it may be possible to combine multiple update rules together, improving synergy between their different behaviors. Discussed below are techniques for how, in some example embodiments, pools may be composed with each other, building hierarchies (i.e., pools of pools) that have complex behaviors. The brick-like combining in composite pools may avoid liquidity fragmentation and/or enable dynamic re-allocation of capital between different update rules/strategies.

In some example embodiments, liquidity fragmentation may be undesirable, and there may be cases where interpretable re-allocation of capital between different update-rues/strategies may be unnecessary, or undesirable. This may be a “flatter” way to combine update rules by creating a new pool, a batched pool, whose update rule may be made by combining many simpler update rules, a procedure that may be referred to as batching. Some or all values in the batched pool may be allocated according to the overall weight-changes of the overall, batched, update rule—a single pot.

There may be many ways to be wrong and relatively few ways to be right. When the update rules in the batch are making good decisions, they may be in agreement; however, when they make bad decisions, their outputs may be bad in different ways. Thus, by averaging their outputs, the good choices may be amplified, and the bad choices may cancel each other out (at least partially). This averaging is similar to ensembling in applied statistics, where many small models are average to give an overall output.

Concretely, given a set of M update rules, which may take the form shown in equation (8) in Appendix 2, an ensemble update rule may be made by taking the average of their output. In this case, the ensemble update rule w_{ensemble}(t) may be denoted by equation (28) in Appendix 2, and if the constituent update rules output changes of weights, as in equation (10) of Appendix 2, the batched weight vector w_{ensemble} (t) may be denoted by equation (29) in Appendix 2. For some classes of update rules, there may be ways to share/cache computation of a set of update rules being batched together, thereby reducing running costs.

Oracles may be attacked. Some smoothed estimators may be more robust to oracle attack than naïve estimators. There may be a need to determine how it changes as a function of the newest oracle value p(t). The completely naive gradient estimator is shown in equations (30) and (31) in Appendix 2, so any changes in oracle value may pass one-for-one over to changes in this naive gradient.

For a smoothed estimator, by rearranging equations (5)-(7) in Appendix 2, equation (32) may be derived, from which the dependence of β(t) on p(t) as shown in equation (33) in Appendix 2. For any value of λ, the smoothed estimator may be less affected by the new oracle value, so larger attacked-oracle values may be needed to get a matched change in output. λ=0.8 (a reasonable value) may give a smoothed estimator x25 more robust than the naïve estimator.

Various example embodiments may allow for multi-token trades. For example, a trader wishing to exchange a particular set of tokens, which may be represented by the vector Δ, for another set of tokens Λ, where entries in each are ≥0. The protocol may require, for tokens i where Δᵢ>0, that Λᵢ=0: tokens may not be traded for themselves. With fees (1−γ), for a trade to be accepted, equation (34) in Appendix 2 must be satisfied.

Some example embodiments may take a dynamic position in the marketplace, changing the weights in the pricing function for tokens on the fly, so via providing arbitrage opportunities it may increase its proportional holdings in some tokens and decrease its proportional holdings in others, in a manner designed to earn a return for LPs. Reserves may then be adjusted to be consistent with external markets. Thus, the protocol may offer lower fees to traders wishing to exchange tokens than on other protocols where trader fees are needed, because of impermanent loss, to attempt to make LPs whole.

Considering a swap, a token-pair trade, i.e., Δ and Λ may both be further restricted to be one-hot. The trader may wish to exchange Δⱼ of the j^{th} token for some amount. Λₖ of the k^{th} token, j≠k. Some example embodiments may provide a pool's quote for the amount Λₖ that it will accept for the trading-in of Δⱼ, via inversion of equation (34) in Appendix 2, as shown in equation (35) in Appendix 2.

Various example embodiments may find unscaled prices, p^{TFMM}(t), offered by some example embodiments (e.g., in the case of 0 fees) by taking the derivative of its defining function, as provided in equation (4) of Appendix 2, with respect to the vector of reserves held, as shown in equation (36) of Appendix 2, wherein the division in the final fraction is calculated elementwise. Similarly, to calculate p_{i,j}^{TFMM}(t), the prices of the i^{th} token in terms of the j^{th}, that is using the j^{th} token as the numéraire, simply divide the i^{th} unscaled priced by the j^{th}, as provided in equation (37) of Appendix 2. Equation (37) makes explicit the relationship between the trajectories of a pool's weights and the prices it quotes. If the weight of token i increases relative to token j, the price of the token i may increase relative to token j; conversely, a decrease in the relative weight of token i may result in a decrease in its price, such that trading pushes the reserves out of token i and into j.

In various example embodiments, depositing and withdrawing liquidity to and from a pool P may correspond respectively to increasing and decreasing the pool value k(t), which may provide a unitless scalar measure of the size or “value” of the pool's reserves, given its current weights. Similar to the pools on existing DEXes, each pool may issue liquidity tokens to LPs in proportion to the value they place in a pool. At time t, the total supply of liquidity tokens τ_{ρ}(t) for a pool P may be provided according to τ_{ρ}=s(w(t))k(t), where s is a scaling factor that determines the total size of the supply.

Depositing all the assets in a pool in proportion to their existing supply may scale k accordingly (where for now k's explicit time dependence is dropped to minimize clutter). That is, when Δᵢ tokens of each asset i are deposited, where Δᵢ=cRᵢ for some scalar c, the reserves therefore may change according to the map Rᵢ→(1+c)Rᵢ, and hence the value of k may map according to k→(1+c)k. The depositor may therefore be allocated cτ_{P} new liquidity tokens, and the total liquidity tokens supply may evolve as τ_{P}→(1+c)τ_{P}. This process may be referred to as an all-asset deposit.

An LP does not have to deposit all the assets in a pool to obtain liquidity tokens, but may deposit any quantity of any of the underlying assets, and obtain tokens in exchange for the increase in pool value. Since liquidity tokens are issued in exchange for increasing the value of k, it may be needed to know how many tokens would be issued if k is increased to a new value k′. Since the number of liquidity tokens τ_{P} may be proportional to k, this may result in equation (38) of Appendix 2, wherein τ′_{P} is the new supply of liquidity tokens, and δ is the new issuance.

In some example embodiments, an LP may wish to deposit assets in quantities given by Δᵢ, where i ranges over the assets in the pool. This may result in equation (39) of Appendix 2, and hence equation (40) in Appendix 2. In the case of a single-asset deposit, this may be denoted as equation (41) in Appendix 2.

Conversely, a LP may redeem liquidity tokens (thereby reducing τ_{P}), and thereby withdraw assets from the pool—and there may be corresponding formulae for all-asset and arbitrary-asset withdrawals, obtained by taking the change 8 in token supply to be negative. These formulae may also be inverted to obtain expressions for how many tokens of given asset types must be deposited (or withdrawn) to acquire (or destroy) a certain number of liquidity tokens.

Certain techniques exist for “concentrated liquidity” where trades may be performed “as if” a pool contains more reserves than it in fact does. If liquidity is concentrated by quoting trading using these virtual reserves, that are greater than the true reserves, then it may be possible for trades to remove all of the reserves of any token in the pool by a single trade or a sequence of trades. This has the effect of making the reserves of a pool only available within a certain range of market prices. This may provide an advantage of reduced slippage for traders, as higher reserves in a pool may naturally decrease the curvature of commonly-used trading functions. This means that pools with concentrated liquidity may be more appealing for traders compared to those that do not concentrate their liquidity, all else being equal. Some previous techniques have implemented concentrated liquidity for pools composed of pairs of tokens. Some example embodiments herein extend the virtual resources approach to pools with non-uniform weights over tokens and simultaneously to multi-token pools.

Some example embodiments may include pools that have, in a given block, the invariant equation (42) in Appendix 2. Reserves may be scaled uniformly by a factor ν(≥1) to obtain virtual reserves, Řᵢ, as shown in equation (43) in Appendix 2, and further require that these new virtual resources follow a matched virtual invariant function as shown in equation (44) in Appendix 2. Substituting in Řᵢ=νRᵢ, this may yield equation (45) in Appendix 2.

While initial reserves may be scaled, in effect pretending the pool has more reserves that it does, the trade amounts (i.e., the number of tokens going into an out of these pools) must be the number of tokens the trade is wishing to exchange. Both true and virtual token reserves may change by the same amount. Allowed trades may include those replacing Rᵢ with νRᵢ in equation (34) of Appendix 2, resulting in equation (46) in Appendix 2. And the concentrated equivalent to a token-pair trade, as shown in equation (35) of Appendix 2, trading Δⱼ of token j into the pool in exchange for the Λₖ of token k, results in equation (47) of Appendix 2. After a trade has been completed, primes may be used to denote post-trade quantities, as shown in equations (48), (49), and (50) of Appendix 2. The post-trade invariants of the virtual resources, as shown in equation (44) of Appendix 2, may be in terms of the true reserves, as shown in equation (51) of Appendix 2, which shows that the virtual invariant may be a scaled and shifted version of the original invariant.

Underlying, true token reserves may not be below zero, so R_{i,min}=0. This may place restrictions on the virtual reserves, as shown in equation (52) of Appendix 2, which is intuitively the case since initial virtual reserves are νRᵢ, and then Rᵢ may be removed from them. The maximum value of the virtual reserves may depend on whether the true reserves of all other tokens go to zero. The maximum value Ř′i may reach, in the no-fees-case, is shown by equation (53) of Appendix 2. Thus, the corresponding maximum value of the true reserves is shown by equation (54) of Appendix 2.

A pool is in equilibrium if the actual division of value between assets is in accordance with its weight vector w. If that is the case, w is be the division of value over assets in a pool. At time t₀, for market prices pᵢ(t₀) and pool reserves Rᵢ(t₀), for a pool in equilibrium, it may be the case shown in equations (55)-(58) of Appendix 2, where V(t₀):=Σᵢ₌₁^{N}pᵢ (t₀)Rᵢ(t₀) may be the value of the pool, in the numéraire of the market prices pᵢ (t₀).

As mentioned earlier, the slippage in a trade is a function of the curvature of the underlying trading function. In order to improve the experience of traders, a “virtual” pool may be found which has less curvature that the original, and expose that new virtual pool's trading function to a trader to interact with. It may be desirable to find an invariant function of the same geometric form as the original, but scaled and translated in such a way that curvature is minimized. This provides N+1 degrees of freedom, with one for each translation in a token direction and an overall scaling. However, these movements of the trading function have the potential to change the quoted prices of the pool. If trading using the virtual trading function is done using prices that are inconsistent, the system will create enormous and costly arbitrage opportunities. That is, the gradient of the virtual trading function with respect to virtual token reserves, evaluated at the virtual reserves the true reserves are mapped to, may match the gradients of the original trading function evaluated at the true reserves. These requirements take up N degrees of freedom, meaning that the set of possible virtual reserves can be parameterized by a single parameter, ν.

In selecting value to set ν, pool creators may choose a particular value based on their analysis, analogous to how update rules' parameters are set; but also, if they prefer, they may choose an external smart contract to be called at the same time as the weight update call to calculate a dynamic ν(t) that depends on market conditions, including via a non-linear function, which may include external oracle calls.

In various example embodiments, pool reserves, and pool values, may change. Previous DEXes' pools may have fixed weights, leading to impermanent loss. As explained above, in previous DEXes, LPs may suffer from impermanent (i.e., divergence) loss: any change in the ratios of the market prices of tokens in a basket leads to that pool holding less value that when the pool was capitalized. When the market prices change in ratio, the LPs (in the absence of fees) are be guaranteed to be outperformed by those who simply held their initial capital. While some examples discussed herein use ν=1, but the results may by generalized by replacing Rᵢ with νRᵢ for ν>1. Market price change from some initial value p(t₀) to a later value p(t′). At the initial moment, assume the quoted prices of the pool match the market prices—the pool is, at that moment, in equilibrium. Then, given that change in market prices, arbitrageurs may trade with the pool until, again, the quoted prices of the pool match the new market prices. Performing this analysis, the pool's reserves at a later time t′ may be denoted by equation (59) in Appendix 2, where multiplication and division between vectors may be performed elementwise. The value in a pool, in the market-price numéraire, at any time t is V(t)=p(t)·R(t)=Σᵢ^{N}pᵢ(t′)Rᵢ(t). This may result in equations (60) and (61) in Appendix 2. To get the impermanent loss equations, the change in the pool value from t₀→t′ to the change in value of the initial reserves R(t₀), V_{hold}(t)=Σᵢ₌₁ⁿRᵢ(t₀)pᵢ(t), resulting in equations (62) and (63) in Appendix 2, as used in equation (55). Thus, this may result in ΔV, the proportional change in the value of the pool compared to holding, as denoted in equation (64) of Appendix 2. This function range is ≤0, due to the weighted AM-GM inequality; thus, for any p(t′)≠bp(t₀) (where b>0 is any scalar), ΔV<0 so LPs have lost value compared to holding their initially-deposited capital.

In various example embodiments, holdings, and thus value, of a pool may change when the weights are updated, especially for constant market prices with changing weights. Given a change in pool weights, arbitrageurs may trade with the pool until the quoted prices of the pool match the current market prices, using weights w(t′) with time t′=t₀+δₜ and new weights w(t′), but still p(t′)=p(t₀). This provides a weight-update counterpart to equation (59) in Appendix 2, shown by equation (65) in Appendix 2, where multiplication and division between vectors are performed elementwise. This leads to the weight-update counterpart to equation (61) in Appendix 2, the value after the weight-change, provide by equations (66) and (67) in Appendix 2, which does not admit a simple form in the same way of equation (61) where V (t₀) may be removed from the sum.

Furthermore, equation (59) in Appendix 2 is state dependent, not path dependent. In state dependent systems, the terms involving intermediate values of variables cancel out, while in path dependent systems, they do not cancel out. Thus, for DEX pools with fixed weights, if prices go from p(t₀)→p(t′)→p(t″), R(t″) may be rewritten using the variables p(t″), p(t₀), and R(t₀). The terms involving p(t′), R(t′) then cancel out. In contrast, in equations (65) and (67) in Appendix 2, the entire trajectory of weights determines how the reserves and value may change.

When market prices change in certain example embodiments, equations (59) and (65) in Appendix 2 may model how reserves change. Changes-of-weights may be interspersed with changes-of-prices. For a single block within which the market prices change and then at the end of the block the pool updates its weights, equation (68) in Appendix 2 is the resulting equation, where multiplication and division between vectors is performed elementwise. From the path-dependency of equation (65) in Appendix 2, this combined update is also path dependent and now depends upon both the trajectory of prices and that of weights. The corresponding change in value for one combined update is shown in equations (69) and (70) in Appendix 2. Thus, some example embodiments may not suffer from impermanent loss (but of course capital is at risk, update rules can be ill-tuned or have market behavior change such that they no longer operate as expected). The value of a pool in some example embodiments depends on the sequence of weights and prices over time, and its value may increase above simply holding capital.

In a scenario where the weights may change every block without action by the arbitrageur, an arbitrage opportunity may increase every block, assuming constant market prices. This may mean that in effect there is a form of reverse Dutch auction taking place, where the amount a TFMM pool may pay to rebalance increases with blocktime. Thus, the arbitrage opportunities of TFMM pools may result in healthy competition between arbitrageur for who can first fulfill the arbitrage trade, ahead of competitors, by having the leanest, lowest-cost method of arbitraging.

In some example embodiments, weights may change when the pool is in equilibrium—quoting the market price—creating an arbitrage opportunity. This may be desirable to incentivize the pool's reserves to be re-balanced in-line with the new weights. It may also be desirable to LPs for the arbitrage opportunity to be smaller rather than larger. This may be similar to “execution management” in TradFi, where a trader may desire to have transactions to follow best execution policies that may reduce cost. One technique to reduce arbitrage opportunity from a weight update is to spread out the weight update out over a period in time. Thus, when weight updates are divided up into a series of smaller steps, the total resulting arbitrage from all of those multiple steps is less than if the update were performed in one step, under the assumption that market prices are constant over the period of time in which weights are changing.

Equation (71) in Appendix 2 provides such a result. It may be desirable to compare R^{1-step}, the reserves in the pool when the weights are directly updated from w(t₀)→w(t₀)+Δw, a one step process, to R^{2-step}, the reserves following this weight update via a two step process: w(t₀)→w(t₀)+½Δw→w(t₀)+Δw.

The ratio between R₂₋ₛₜₑₚ and R₁₋ₛₜₑₚ may be greater than or equal to one. When Δwⱼ is >0, its term in the product is >1, as a number >1 raised by a positive power. When Δwⱼ is <0, its term in the product is >1, with a number <1 raised by a negative power. When Δwⱼ is =0, the term in the product is 1, as a number raised to the power 0. Thus, for any weight change currently being done in one leap, there is an improved weight update procedure by going through and equilibrating at the midway value. After applying this “bisection” once, this may be applied on each half of the new procedure, dividing changes in weights in half again. Thus, weight changes may be maximally smooth. For given start and end weights, choosing to linearly interpolate the value of the weights in the pool at block-level resolution is thus a simple and effective way to provide smooth weight changes.

While it may be better to be smoother, and to be smoother in this linear-bisection manner, this peaks at the block resolution. There may be additional capital-efficient ways for pools to provide arbitrage opportunities to the market that use non-linear interpolations. One technique to address this is via calculus of variations to find the trajectory of weights that minimize the amount that is paid to arbitrageurs. This may not have a clear closed-form solution, even when making the assumption that prices are constant over the weight-interpolation period. However, it may be numerically calculated. For example, for a sequence of ƒ+1 weights, indexed from to to t_{ƒ}, {w(tₖ)}_{k=0 . . . ƒ}, and constant prices the final reserves are provided in equation (72) of Appendix 2. Within this framework, this may be attacked as an optimization problems, since the goal may be to find the trajectory of weights that minimizes the amount that is paid to arbitrageurs (i.e., maximizes the pool value subject to constraints on the weights, as shown in equation (73) of Appendix 2, which fulfills the Karus-Kuhn-Tucker (KKT) conditions with {μ_{l,m}} and {Λₖ} as multi-pliers. The optimum may be numerically calculated, as can more sophisticated approaches including changing prices (or even uncertain predictions of future prices) and the presence of fees. These calculations may be run on-chain or otherwise made available to a TFMM pool. During a weight update call, it may be possible to put in an external oracle call that returns a “weight trajectory array.” There may be a trade-off in greater costs versus the improvement from a more-complex weight trajectory. The greater a pool's total value locked (TVL) and the cheaper the weight trajectory oracle call is, the easier it may be to justify this expenditure.

By splitting up the arbitrage opportunity, pools in some example embodiments may re-balance to their re-weighted holdings extremely cheaply, being competitive with or outperforming re-balancing via interacting with a centralized exchange. Simulations of rules in example embodiments have been run in a matched way interacting with a CEX assuming no slippage, trading at market mid-price, minimal fees (only charged on trades out from a pool), and tuned re-balancing frequency to minimize churn. While exact performance may depend on the basket of tokens and the update rule used, over a supercycle, some example embodiments commonly contain 50% more value in them compared to matched simulations of CEX re-balanced pools.

Assuming constant market prices over the course of interpolation, a cheap-to-compute approximation to the zero-fees solution of equation (73) in Appendix 2 may provide a superior method of pool rebalancing over linear interpolation.

Assuming that the weight change from w(t₀)→w(t_{ƒ}) is small, equation (74) in Appendix 2 may be directly optimized without needing to impose the constraints of equation (73) of Appendix 2. This may yield the optimal intermediate value shown in equation (75) in Appendix 2, where W₀(·) is the principal branch of the Lambert W function, and e is Euler's constant. The Lambert W function is a special function, the solution to a transcendental equation, so not trivial to compute on-chain. While there may be methods to approximate W₀(·), these may require nested calls to log (·), that are not ideal for constrained-compute environments, and may be best over particular ranges of inputs while the ratios of start and end weights may take a broad range of values. The values of \tilde{w}* (i.e., the optimal intermediate weight in a two-step process) are bounded from above and below by the arithmetic mean and geometric mean (respectively) of {wᵢ(t₀), wᵢ(t_{ƒ})}, as provided in equation (76) of Appendix 2. The arithmetic mean of the geometric and arithmetic means of {wᵢ(t₀), wᵢ(t_{ƒ})} may provide a simple and effective method for approximating the optimal intermediate weight.

The approximations may be used to give close-to-optimal multi-step weight trajectories, even though the base analytic result provided in equation (75) of Appendix 2 may only be for a single intermediate point. Along a trajectory of many intermediate weights, the optimal \tilde{w}ᵢ at any stage in that trajectory will lie above the geometric mean of the prior and post weights and below their arithmetic mean. The approximately-optimal ƒ−1-step weight trajectory {\check{w}(tₖ)}_{k=1, . . . , ƒ=1} for going from w(t₀) to w(t_{ƒ}) may be made by taking the average of the linear interpolation between these values and the geometric interpolation between these values, and provided in equations (77)-(79) of Appendix 2, which normalizes weight trajectories to enforce that they sum to 1 at each time step.

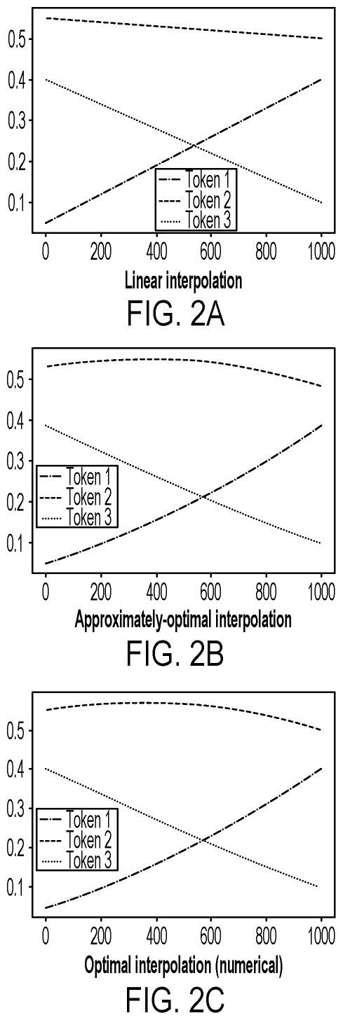

The optimal trajectories may be provided by {w*(tₖ)}_{k=1, . . . , ƒ-1} by numerically solving for equation (73) in Appendix 2 for a given choice of N, ƒ, w(t₀), and w(t_{ƒ}). In FIG. 2, the linear interpolation may be compared with {w*(tₖ)}_{k=1, . . . , ƒ-1} and numerically-found w(t_{ƒ})={0.4, 0.5, 0.1}, and this may be performed over ƒ=1000 steps. Due to the accuracy of the approximately-optimal series to the numerically-found optimal trajectory, the latter two curves may be difficult to visually distinguish.

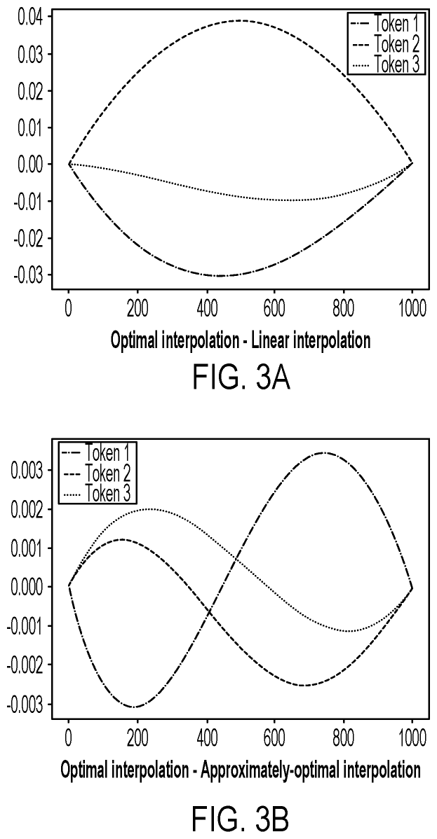

In FIG. 3, the difference may be taken between numerically-found {w*(tₖ)}_{k=1, . . . , ƒ-1} and each of linear and approximately-optimal interpolations. In this example, the approximately-optimal trajectory {\check{w}(tₖ)}_{k=1, . . . , ƒ=1} has a maximum absolute deviation of weights of ≈0.003 from the numerical optimal trajectory {w*(tₖ)}_{k=1, . . . , ƒ-1}, compared to ≈0.04 for linear interpolation.

Based upon the above, how TFMM pools' reserves and value change when the weight changes are small is of particular importance. From this, TFMM pools rebalance can be studied, including when fees are present. As an example, if there is a very small change in weights, equation (80) in Appendix 2 may be used, where the components δ_{w}_{ᵢ}<<1. Starting with equation (65) in Appendix 2, rearranging, and then introducing equation (80) in Appendix 2, may yield equations (81) and (82) in Appendix 2. Using this with equation (67) in Appendix 2, small weight changes may be provided by equation (83) in Appendix 2. As a result, for small weight changes, to first order, a TFMM pool may act as an optimum rebalancer: the value of the pool may not change under rebalancing.

Handing the trading function of a geometric mean market maker may be complicated as generally one ends up with implicit functions. The effect of a trade with fees on pool value is to increase the value held in the pool, and this amount may be bounded from below by simply the fees time the value of the assets being traded into the pool, as shown in equation (84) of Appendix 2, where Δ is the vector giving the assets being traded into the pool. Applying this to equation (83) in Appendix 2 may yield equation (85) of Appendix 2. A simpler form of equation (86) of Appendix 2 can be derived. These results may show how a TFMM pool rebalancing may lead, with fees present and under the assumptions made (including being in the limit of small weight changes and having constant prices) to an increase in value of the pool. Equation (86) of Appendix 2 may provide this result.

The equivalent results may be derived the equivalent results for a more standard rebalancing procedure, such as by using a CEX. The CEX-rebalancing counterpart may be shown in equation (86) in Appendix 2. Here, the pool is a taker, providing the LP-rebalancing results above. As a result, the pool may be worth slightly less than V (t₀) after the rebalance, rather than slightly more.

Some example embodiments may include constraints on the values that can be taken by the entries of the portfolio weight vector w(t). Having the pool put all its reserves into one token may be undesirable. Thus, the entries of w(t) may be bound according to equation (50) in Appendix 1, where ϵₘᵢₙ=1/2N and

$${ϵ}_{max} = 1 - \frac{1}{2 N} .$$

This may be implemented by checking the updated weight vector for entries outside the permitted range and redistributing the out-of-bound portfolio “mass” between entries.

Similarly, the maximum-allowed size of weight updates may be capped according to equation (51) in Appendix 1. One aspect in example embodiments is whether, through the weightings between tokens changing over time, their temporal dependence may lead to an opportunity for a front-running attack against LPs. This may be similar to a “sandwich attack” on a trade made on a standard DEX pool. When weight updates are smoothed-out as described above, over many blocks, the changes in weight occurs between blocks. This may render weight updates reminiscent of trades in time-weighted average market makers. Thus, any attacker may have to do an MEV attack over multiple blocks; being the last transaction of one block and the first of the next. This may reduce the possibility of “sandwich attacks” on the weight updates as it may require multi-block MEV manipulation.

As an example, a weight change may be similar to a trade, both changing the quoted prices of a pool (similar to equation (30) in Appendix 1), the first by changing w, the second by changing R. As both change prices, they may create arbitrage opportunities; pools may benefits from arbitrageurs receiving quoted prices to match the market prices. However, in a sandwich attack, a pre-trade is done that magnifies the size of the arbitrage opportunity caused by the sandwiches trade, enabling greater return to the attacker than if they had merely arbitraged the trade afterwards. Similar to how trades should be of a sufficient size for a sandwich attack to be viable, for a given level of fees and a given maximum trade size, a weight change should be above a certain size to be sandwich-able.

Thus, dividing a weight update into many smaller steps may be advantageous in many example embodiments as it minimizes the cost paid to arbitrageurs, as well as providing a second benefit of small weight-change steps where, in the presence of fees, they provide protection from a multiblock MEV attack.

Various example embodiments may include a pool creation tool for enable modelling and designing of pools, and estimating all the example rules discussed above over selected tokens and parameters. The pool creating tool may be applied to a basket of cryptocurrencies (e.g., wETH, wBTC, wADA, and DAI), using market data over a given market economic cycle.

Oracle/update rule calls may occur every hour, with the pool SDK modelling the action of arbitrageurs using minute level oracle data. Weights may be interpolated to the desired value of the following hour, with all guard rails applied as described above. Arbitrageurs may arbitrage the pools every 5 blocks, and thus this modelling does not assume perfect arbitrage.

For many update rules, a desirable pool may have assets that are relatively uncorrelated with each other. For momentum, it may also be desirable if the pool contains assets that are anti-correlated with each other to provide diversity. If all the assets were perfectly correlated with each other, this may be similar to having one asset in the pool, possibly negating some benefits. DAI, a stablecoin, has an approximately constant value that is nearly uncorrelated with other assets. Similarly, Cardano (ADA) is a large market-cap, highly-liquid token that is less correlated with BTC/ETH than other similar-market-cap tokens. There are times when ADA is anti-correlated with BTC, which may make it a useful addition to the pool.

The update rules described above may only have two parameters. This simplicity improves the performance for a broad range of differently-parameterized pools that use the same update rule. Thus, for each rule, a grid may be plotted for each value of its two parameters to show Jensen's Alpha of that particular choice of parameters for that rule, benchmarked against not using various example embodiments. This modelling may assume no fees, which would be a conservative assumption since it reduces pool performance.

Each pool may begin with equal value of each token, such as w(t₀=¼, ¼, ¼, ¼). As the underlying decay constant parameters present in update rules (λ used in gradient or covariance estimation, the decay constant A used in smoothing a sequence of MVPT weights), the effective “memory length” of these processes may instead be plotted. This may represent the time it takes for a previous observation to have later no lingering effect on the present value of estimated quantities. Also, the “step size” parameter k present in many rules may vary, so this may be represented as a (base 2) logarithm instead. The anti-momentum update rule may be preferred in bear runs, which may be demonstrated over the recent bear run from November 2021 to July 2022.

For a broad range of parameter values, some pools of example embodiments may outperform holdings the initial capital, indicating the robustness of various example embodiments in improving computer-driven trading markets. As discussed above, various example embodiments may have vector parameters (different values for each constituent) rather than scalar parameters (one value for all constituents), which may improve performance as different constituents may have different properties; however, this may not be clear from heat maps.

FIGS. 2a-2d depicts the backtest of various update rules for a wETH, wBTC, wADA, and DAI basket over a supercycle from February 2021 to July 2022 for each over a range of parameter values. Jensen's Alpha may be plotted using other techniques as the benchmark. For the minimum-variance pool, DAI may not be included; as a stablecoin, DAI has diminishing covariance, so it may dominate any minimum-variance pool it is in. Anti-momentum may also be demonstrated in a specific market condition, the start of the latest bear market from November 2021 to July 2022. This may show how you can construct market-condition-specific base pools that may be of use within a composite pool, as discussed below. Note that the rules that involve a step-size k (all but min-variance) are here parameterized by \tilde{k},

$$\tilde{k} = \frac{k}{{t}_{m e m}} ,$$

where tₘₑₘ denotes the memory length of the estimator for the current rule. This may be a more natural parameterization as longer memory lengths (which may come from larger λ values) lead to smaller gradient estimators, so it may be reasonable for the used k to be scaled by the memory length tₘₑₘ.

FIG. 3 illustrates a histogram of returns for different momentum pools shown in FIG. 2a, relative to standard methods. FIG. 2 also shows the return for the batched momentum rule, the black line, made by averaging this entire set of updates rules to construct a new batched update rule. This batched rule may have a return of ≈0.8 over this period.

The performance of a batched pool, as discussed above, may also be affected by averaging the outputs for every different setting of the parameters from FIG. 2a. There are 61×61=3,721 pairs of values of λ, k (as in the plot linearly-spaced in memory length and T_{\tilde{k}}) and then using that average-weight-update as the weight change. This batched pool, over the same super cycle as in FIG. 2a, may give a Jensen's Alpha, benchmarked against standard methods, of 253%. This performed better than the best pools, without needing any sharp a-priori tuning; it may only need the choice of a broad range of parameter settings.

To show this effect in detail, FIG. 3 provides the histogram of returns for the momentum pools (each set of parameters) in FIG. 2a over the super cycle, relative to standard methods, to isolate cleanly the benefits of the update rules. The return for the batched momentum rule is also plotted that is built from the entire set of update rules. Thus, without tuning, this update rule may result in improved performance as the best momentum pools over this period.

One challenge with existing AMMs when attempting to manage LP value is that trades are executed against pools containing only two or three assets; such small baskets of tokens have downsides since they do not allow for broad exposure to different tokens. LPs seeking to distribute their liquidity across multiple assets may either deposit in a low-volume pool covering the assets of interest with their desired weighting (where on current DEXes they will still suffer impermanent loss), or they can deposit across a number of small pools, therefore benefiting from the improved trade volume, as the cost of manual, off-chain, management of their positions.

The architecture of various example embodiments enables LPs to circumvent this dilemma, through composite pools constructed by pooling pools. The liquidity placed in a composite pool may be constructed out of a momentum wETH-wBTC pool and an anti-momentum wETH-wBTC pool. The momentum pool may perform better in some market conditions, while anti-momentum may perform better in others. If the composite pool itself runs a momentum strategy over these two base pools, it may be dynamically changing its dominant strategy, depending on market conditions. This example illustrates how composite pools may be used to build more advanced update rules, over the basket, from simpler rules.

Another example may include the creation of a risk management update rule, which may allow the composite pool to re-balance according to the risk profiles of the underlying pools, and allowing for pool controlled automatic risk management and automatic strategy based constituent token re-balancing. In addition, composite pools made be made out of any combination of pools, including other composite pools, which can have between them any amount of overlap in tokens they contain.

A composite pool system may also have the benefit of improving liquidity for traders, as liquidity does not need to be removed from small-basket high-volume pools in order to capitalize broader-based composite pools.

In addition, it may be highly-economical for a composite pool to move value between base pools, as LPs may not have to pay trade fees or withdrawal fees when their value goes from one base pool to another. This renders composite pools a very different offering from protocols that externally-manage LPs' holdings between different (non-dynamic) DEX pools. This may only be possible in various example embodiments because of the protocol's single value architecture design. Further, that design may also make possible reduced slippage swaps if a composite pool requires a re-balancing transaction analogous to an internal transfer of a single token from one of its base pools to another.

As discussed below, the construction of three fundamental types of composite pool may include the following: subpools; (weighted) sums; and quotients. As mentioned above, some example embodiments may include a pool that is determined by a finite set T={i, j, . . . } of tokens, a T-indexed vector w(t)={wᵢ}_{i:T} representing the weights, and a T-indexed vector R={Rᵢ}_{i:T} representing the reserves, such that Σ_{i,T}wᵢ=1. This information may be used to determine the pool value k(t) according to the trading function defined by equation (4) in Appendix 2. P may indicate the tuple (T, w, R) defining a pool.

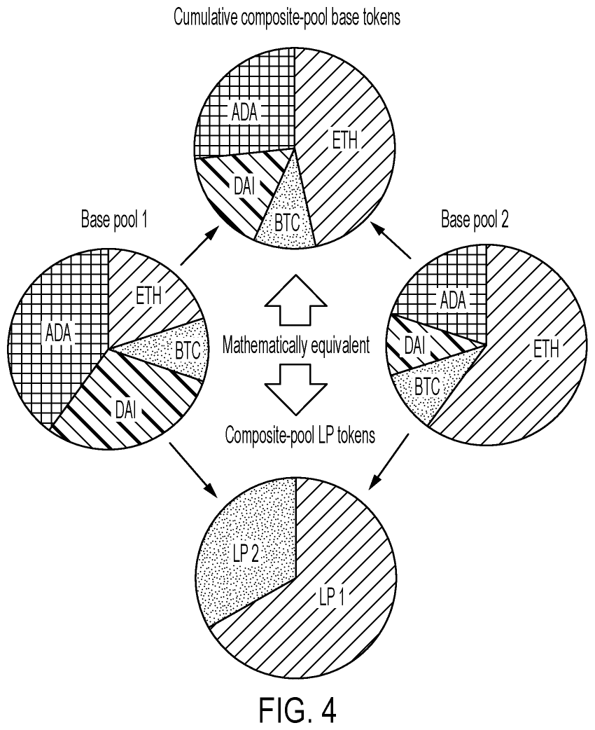

FIG. 4 illustrates a diagrammatic representation of a composite pool composed of two base pools. The base pools are shown left and right, while two mathematically-equivalent representations of a composite pool built on these basepools are given top and bottom. The top of FIG. 4 shows the “cumulative” representation: the composite pool's holdings in terms of the underlying pools' reserve tokens. The bottom shows the “LP token” representation: simply the LP tokens held from the underlying pools. Interpreting and using the cumulative view of a composite pool may improve vault efficiency and price discovery as arbitrage on LP tokens may be unrealistic since their circulation is constrained.

In some example embodiments, a composite pool may include a subpool. For example, given a pool P, an LP may wish to deposit into only a subset U⊂T of its tokens, while otherwise benefiting from its trading volume and weights. In order to do so, the LP may deposit into the subpool P^{(U)} defined as follows. Its set of tokens may be U, and the reserves Rᵢ^{(u)} may be corresponding reserves Rᵢ in P, for i⊆U. Then the subpools weights wᵢ^{U} may be given by wᵢ^{U}=wᵢ/Σ_{i,U} wᵢ, and the pool value is equation (97) in Appendix 2, where j may range over the set T\ U of tokens not in U.

In various example embodiments, a composite pool may be obtained by forming the sum of two pools P⁽¹⁾ and P⁽²⁾, allowing an LP to distribute liquidity across the assets underlying the pools, without having to create a new pool, or perform the distribution manually. In combination with subpools, this may allow LPs to deposit into complex, emergent pools while benefiting from the underlying trade volume.

To construct the sum P⁽¹⁾+P⁽²⁾, the disjoint union T⁽¹⁾+T⁽²⁾ of the sets of tokens may be formed. The reserves may only include the reserves of the underlying pools, and the weights wᵢ⁽¹⁺²⁾ may be given by wᵢ/2, where wᵢ is the underlying weight. A simple calculation may show the value k^{(1|2)} of the sum pool to be given by product of the square roots \sqrt{k⁽¹⁾}\sqrt{k⁽²⁾} of the values of the underlying pools.

The operation of summing pools may extend from this binary case to sums of arbitrary size. Thus, given a collection of pools {P⁽ⁱ⁾}_{i:I}, the corresponding sum composite pool Σ_{i:I}P⁽ⁱ⁾ may be formed by forming the disjoint union of the corresponding set of tokens Σ_{i:I}T⁽ⁱ⁾, and rescaling the weights wⱼ⁽ⁱ⁾ by 1/|I|, where |I| is the size of the index set I.

The notation of sum composite pools extends further to a weighted sum, whereby each constituent pool P⁽ⁱ⁾ of a composite pool may be associated with a “composite” weight ωᵢ. The corresponding pool may be written as {P⁽ⁱ⁾}_{i:I}, and the composite-weights as ωᵢ, which can form a new pool given by a weighted (geometric) sum of their underlying assets, as provided in equation (98) of Appendix 2, where the composite pool weights wᵢ may satisfy the normalization rule that Σ_{i:I} wᵢ=1. This invariant may be equal to the invariant of the weight sum composite pool Σ_{i:I} ωᵢ P⁽ⁱ⁾.

The pool value k⁽ⁱ⁾ may be an unscaled “price” for the pool P⁽ⁱ⁾, based upon how much it would cost to buy one unit of each of the pool's reserves. This may be answered by the sum Σ_{j:T}_{⁽ⁱ⁾} Rⱼ pⱼ^{TFMM}, which may be equal to the value k⁽ⁱ⁾.

As a result, the values of the underlying pools in a composite pool may be price signals, and the composite-weights ωᵢ may be updated, accordingly, using the same algorithm as for the assets in the underlying pools. This provides some of the automated, dynamic abilities and benefits of various example embodiments.

The principal operation by which composite pools are constructed is the weighted sum of pools. Since this operation may include a disjoint union of the underlying sets of tokens, tokens in pool P⁽¹⁾ may be treated as distinct from the tokens in P⁽²⁾, even when those pools have tokens in common and together constitute a composite pool. In order to combine the reserves of these shared tokens, some example embodiments may quotient the composite pool by an equivalence relation identifying them. Since, before quotienting, the reserves of the shared tokens may have disjoint weights, when this quotienting is performed, this may sum the reserves and adjust the weights.

In general, certain example embodiments may quotient any pool by any equivalence relation—not just composite pools by token identity. As an example, ˜ may be an equivalence relation on a pool P, and a quotient pool P/˜ should be formed. The set of tokens of P/˜ may be given by the quotient T/˜ of the set T of tokens of P, whose elements may be equivalence classes [i], such that two tokens j, k⊂T may be elements of the same equivalence class [i] if and only if j˜k according to the equivalence relation ˜. The reserves Ř_{[i]} of ‘token’ [i] in P/˜ may be given by the sum of the underlying reserves: \tilde{R}_{[i]}=Σ_{j∈[i]} Rⱼ. The new weights may then be defined according to equation (99) in Appendix 2. The weights \tilde{w}ᵢ making these equalities true may be given by equation (100) in Appendix 2.

However, in general, Σᵢ \tilde{w}ᵢ≠1, so the weights may be rescaled by \tilde{w}ᵢ→\tilde{w}ᵢ/Σᵢ \tilde{w}ᵢ. This may introduce a corresponding rescaling of k to \tilde{k}=k^{(1/Σ}^{ᵢ}^{\tilde{w}}^{ᵢ}⁾; the underlying value k may be unchanged by these operations, and the quotient weights and reserves may be fully determined by the underlying weights and reserves.

Since composite pools are equivalent to pools containing liquidity tokens (or subpools or quotients thereof), in order to reduce the fragmentation of liquidity and trading activity, various example embodiments may ensure that any pool including a liquidity token is considered as a composite pool containing the pool associated to the liquidity token; any individual token may also be equivalent to a trivial pool containing assets only of that token type.

As a further step to improve trade liquidity, various example embodiments may hold all pool liquidity in a centralized smart contract; some smart contracts may execute trades, dispatching the checks that relevant invariants are satisfied to the underlying pools, but only requiring that the invariants must be satisfied at the end of a transaction. As a result, certain example embodiments may support inexpensive multi-step trades within a single transaction, and allow for pool invariants to be transiently broken within each transaction, as long as the invariants are finally satisfied. This flexibility may be important for composite pool trading: for example, in order to trade across the pools constituting a composite pool, it may be necessary to move liquidity between pools, and the optimal sequence of trades (and joins and exits) may transiently break the invariants of the underlying pools. In principle, this extra flexibility may allow traders to draw on the combined reserves of some example embodiments in order to minimize slippage, and may enable sophisticated manoeuvres such as using flash loans mid-trade in order to resolve broken invariants.

Since example embodiments may rely on relevant invariants being finally satisfied, computing the optimal sequence of operations may be performed entirely in the front end using sophisticated optimization routines. Various example embodiments may then interpret domain-specific trade language, and check the for the satisfaction of invariants.

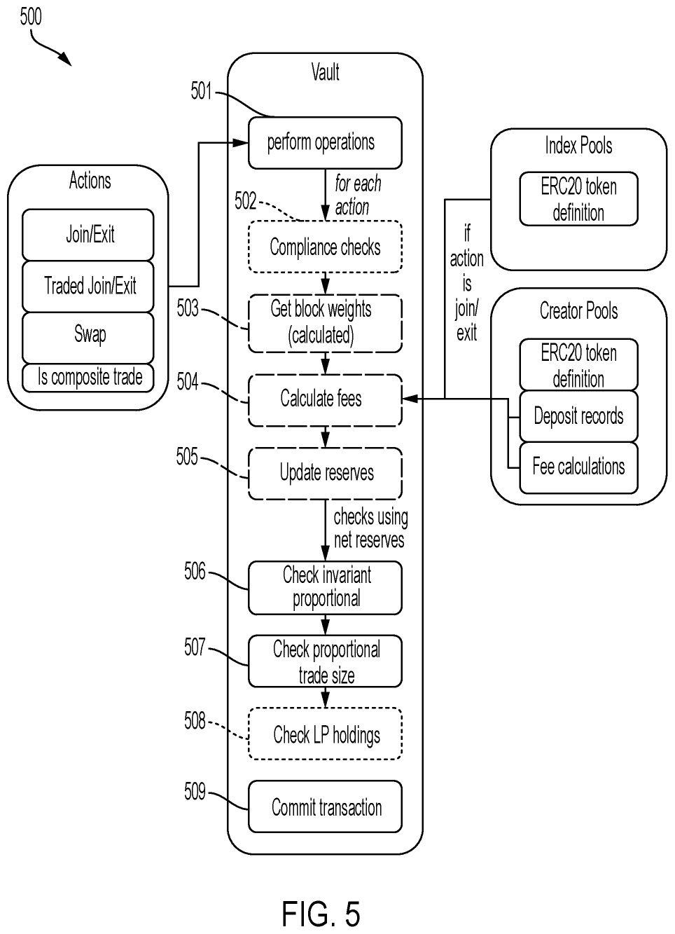

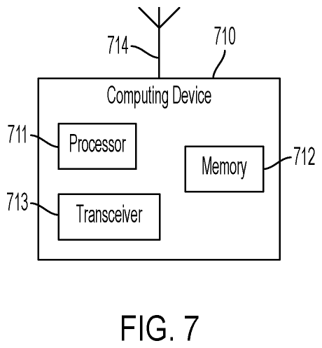

FIG. 5 illustrates an example of a flow diagram of a method 500 that may be performed by a computing device, such as computing device 710 illustrated in FIG. 7, according to various example embodiments.

At step 501, the method may include performing at least one action. For example, the at least one action may include any of creating an entry point, joining/exiting, trader joining/existing, swapping, and a determination of a composite swap.

At step 502, the method may further include, for each action performed at step 501, performing at least one compliance check. For example, the at least one compliance check may include an optional check to external contracts that may be needed to fulfill compliance requirements for a given region, trader, and/or pool creator.

At step 503, the method may further include calculating at least two block weights. For example, the calculating may include calculating specific weights to use in a trading function for a given block index.

At step 504, the method may further include calculating at least one fee. In certain example embodiments, the calculation may be based upon an index pool, such as an Ethereum Request for Comments 20 (ERC20) token definition (i.e., Ethereum blockchain). In some example embodiments, the calculating may be based upon a creator pool, such as an ERC20 token definition, deposit records, and fee calculations. Furthermore, fees may be calculated using a swamp amount requested and/or a preset pool configuration.

At step 505, the method may further include updating at least one reserve. This may include checking for use of net reserves and/or updating the reserve quantities in a vault.

At step 506, the method may further include checking for at least one invariant proportional and/or performing an invariant check, as discussed above.

At step 507, the method may further include checking for at least one proportional trade size (e.g., net change of pool reserves for all trades). For example, there may be a configurable maximum of a pool size that may be adjusted by a trade, which may minimize pool manipulation.

At step 508, the method may further include checking for at least one LP holding. For example, for composite trade, there may be a requirement that a trader omits a net change for LP token holdings, which may prevent using a composite trade to avoid potential withdrawal fees.

At step 509, the method may further include committing at least one transaction to at least one blockchain.

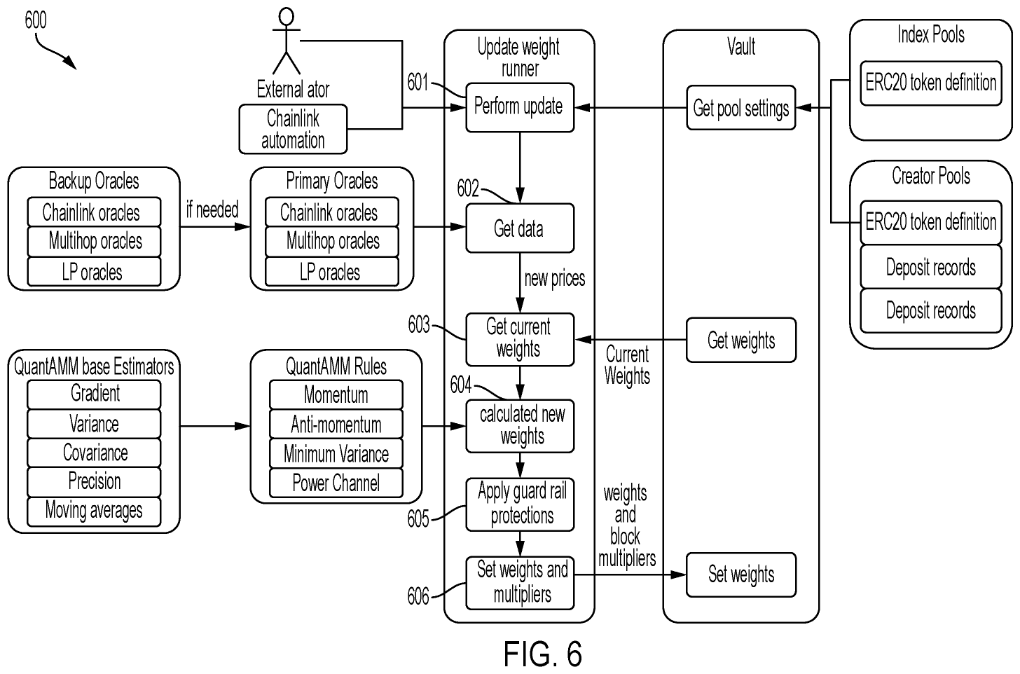

FIG. 6 illustrates an example of a flow diagram of a method 600 that may be performed by a computing device, such as computing device 710 illustrated in FIG. 7, according to various example embodiments.

At step 601, the method may include performing an update. For example, the update may be performed by an external actor.

At step 602, the method may further include obtaining data. For example, the data may be based upon at least one primary oracle (e.g., chainlink oracles, multihop oracles, LP oracles). Furthermore, the at least one primary oracle may be based upon at least one backup oracle (e.g., chainlink oracles, multihop oracles, LP oracles).

At step 603, the method may further include obtaining at least one pool of weights, which may be based on the current weights of the pool retrieved from the blockchain.

At step 604, the method may further include calculating at least two new weights. For example, the new weight may be calculated based upon at least one rule, such as momentum, anti-momentum, minimum variance, and power channel. Furthermore, the at least one rule may be based upon at least one base estimator, such as gradient, variance, covariance, precision, and moving average, which may be converted to the at least one rule using its corresponding estimator. At step 605, the method may further include applying at least one guard rail protection.

In certain example embodiments, a vault may be constructed by an external party or protocol. The claims may apply even with a significant part of the vault infrastructure is provided by an external party. External protocols may provide hooks (e.g., interfaces) to allow custom implementations of functions at the point of the hook when it matches a hook footprint. In some example embodiments, external parties may provide functionality, such as but not exclusively, depositing and withdrawing holdings from vaults, recording balances and analytical features, basic trading interfaces, front-end integrations and screens relating to functioning of the protocol. All claims may be able, if the correct function hooks are available, to utilize existing infrastructure for non-novel aspects of workflows.

At step 606, the method may further include setting at least one weight and/or multiplier. For example, the at least one weight and/or multiplier may be applied to weights to be applied to a liquidity pool.

In some example embodiments, a method may include calculating, by a computing device, at least one entry of a weight vector according to at least one estimator-based rule to be applied to a liquidity pool. These systems, while currently most naturally applied to native cryptocurrency assets, may be configured to process tokenised representations of real world assets. These techniques may also be applied to pools/baskets of assets that include, for example, tokenised commodities and tokenised real estate, in addition to cryptocurrencies.

The method may further include, based at least in part upon the calculated at least one entry of a previous weight vector, storing, by the computing device, the at least one entry of the weight vector onto a blockchain configured to determine whether to perform an exchange of at least one asset for at least one other asset from among a pre-defined pool of other assets. For example, a weight vector may be used to calculate whether or not a trade made against assets held in a pool is valid/acceptable to the pool. This process may be used to exchange assets incoming to the pool (assets A) for outgoing assets B; asset A and B may be each composed of a single asset and may be swapped (as discussed above with respect to token-pair trades). Alternatively, A and B may each be a set of assets, each having a given quantity (as discussed above with respect to multi-token trades); for example, ‘A’ may be ‘0.5 wBTC and 2 k USDC’ and ‘B’ may be ‘20 k DAI and 2.1 wETH’. In either of these cases, a weight vector may be used to determine if it is acceptable to the pool.

In some example embodiments, the at least one estimator-based rule may include at least one of gradient of a blockchain oracle or related function provided on a blockchain at a pre-selected temporal scale; variance of the blockchain oracle or related function provided on the blockchain at the pre-selected temporal scale; covariance of the blockchain oracle or related function provided on the blockchain at the pre-selected temporal scale; precision of the blockchain oracle or related function provided on the blockchain at the pre-selected temporal scale; and moving average of the blockchain oracle or related function provided on the blockchain at the pre-selected temporal scale. Thus, estimators may be algorithms/techniques to calculate desirable versions of gradients, variances, etc. Furthermore, “pre-selected temporal scale” may refer to a temporal scale at which new values are ingested; alternatively, “pre-selected temporal scale” may refer to temporal scale of a calculated output. In various example embodiments, estimators may deviate from standard calculations of these quantities by enabling them to be calculated for/over a tuneable period of time (e.g., the memory length of an estimator as discussed above with respect to exponentially-weighted online least-squares regression, describing the chosen amount of ‘look back’ on prior data).

In various example embodiments, the at least one estimator-based rule may include at least one of momentum; anti-momentum; minimum variance; and power channel.

In certain example embodiments, the at least one estimator-based rule comprises at least one AMM rule.

In some example embodiments, the at least one entry of a calculated weight vector may include at least one AMM weight vector of a pool.

In certain example embodiments, a method may include calculating, by a computing device, at least one entry of a weight vector according to at least one estimator-based rule.

In some example embodiments, the method may further include applying, by a computing device, at least one maximal extractable value (MEV) protection to a value of the at least one entry of the weight vector.

For example, applying the at least one MEV protection may further include at least one limit configured to limit at least one of restricting, by a computing device, the entries in the weight vector to take values that are within a pre-specified range; restricting, by a computing device, the maximum allowed change of the entries of the weight vector from one block index to a future block index; depositing, by a computing device, holdings to the liquidity pool, including as part of a trade; and withdrawing, by a computing device, holdings from the liquidity pool, including as part of a trade.

In various example embodiments, the method may further include storing, by a computing device, at least one entry of a weight vector configured to be applied to a particular liquidity pool. For example, a tangible set may the last set, and the result of the calculation may be stored to the blockchain (i.e., transmitting to the blockchain the result of the calculation). The calculation may be a particular form of ‘transaction’, wherein any action on a blockchain (even if it results in no assets being moved) may be referred to as a transaction.

In certain example embodiments, the method may further include initializing, by a computing device, a weight vector update process after a predetermined period of time elapses since a previous application of the weight vector update process; and receiving, by a computing device, at least one oracle data feed on a blockchain.

In certain example embodiments, a method may include calculating, by a computing device, at least one entry of the block-specific weight vector configured for a trading function for a given block index.

The method may further include, in response to a withdrawal request if one is made, calculating, by the computing device, at least one withdrawal fee based upon a predefined fee structure.

The method may further include updating, by the computing device, at least one reserve.

The method may further include checking, by the computing device, for at least one invariant proportional and/or performing an invariant check.

The method may further include checking, by the computing device, for at least one net change of pool reserves for at least one trades configured for maximum extract value protection.

The method may further include checking, by the computing device, for at least one liquidity provider holding, whether the transaction comprises a withdrawal request or a deposit request as part of a composite pool trade comprising at least one of withdrawal, deposits, and trades of liquidity provider tokens as constituent steps. Thus, the forms of these particular checks may enable composite pool trades—trades within ‘stacked hierarchies’ of pools of assets. Thus, these trades may include smart checks on how LP token holdings have changed.

The method may further include, upon determining that all requirements are satisfied, committing, by the computing device, at least one transaction to the blockchain.

The method may further include determining, by a computing device, at least one signal constructed utilizing at least one of gradient, covariance, precision, or moving average calculated using at least one estimator; and transmitting, by a computing device, the determined at least one signal to a market as a continuous feed, stochastic feed, or blockchain oracle.

For example, the at least one estimator may include at least one of gradient of a blockchain oracle or related function provided on a blockchain at a pre-selected temporal scale; variance of the blockchain oracle or related function provided on the blockchain at the pre-selected temporal scale; covariance of the blockchain oracle or related function provided on the blockchain at the pre-selected temporal scale; precision of the blockchain oracle or related function provided on the blockchain at the pre-selected temporal scale; and moving average of the blockchain oracle or related function provided on the blockchain at the pre-selected temporal scale.

The method may further include calculating, by a computing device, at least one component of AMM trading function based upon at least one non-linear technique for a plurality of ledger blocks.

The method may further include performing, by the computing device, at least one compliance check.

FIG. 7 illustrates an example of a system according to certain example embodiments. In one example embodiment, a system may include computing devices, such as, for example, computing device 710.

Computing device 710 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, computing device 710 may be one or more of a citizens broadband radio service device (CBSD).

Computing device 710 may include at least one processor, indicated as 711. Processor 711 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 712. The memory may be fixed or removable. The memory may include computer program instructions or computer code contained therein. Memory 712 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processor 711, memory 712, and any subset thereof, may be configured to provide means corresponding to the various blocks of FIGS. 1-5.

As shown in FIG. 7, transceiver 713 may be provided, and one or more devices may also include at least one antenna, illustrated as 714. The device may have many antennas, such as an array of antennas configured for multiple input multiple output (MIMO) communications, or multiple antennas for multiple RATs. Other configurations of these devices, for example, may be provided. Transceiver 713 may be a transmitter, a receiver, both a transmitter and a receiver, or a unit or device that may be configured both for transmission and reception.

The memory and the computer program instructions may be configured, with the processor for the particular device, to cause a hardware apparatus, such as a computing device, to perform any of the processes described above (i.e., FIGS. 1-5). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 1-5. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

According to certain example embodiments, processor 711 and memory 712 may be included in or may form a part of processing circuitry or control circuitry. In addition, in some example embodiments, transceiver 713 may be included in or may form a part of transceiving circuitry.

In some example embodiments, an apparatus (e.g., computing device 710) may include means for performing a method, a process, or any of the variants discussed herein. Examples of the means may include one or more processors, memory, controllers, transmitters, receivers, and/or computer program code for causing the performance of the operations.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### Partial Glossary

AM Arithmetic Mean
AMM Automated Market Maker
CEX Centralized Exchange
CFMM Constant-Function Market Maker
DEX Decentralized Exchange
DeFi Decentralized Finance
GM Geometric Mean
L2 Layer 2
LP Liquidity Provider
MEV Maximal extractable value
MVPT Mean Variance Portfolio Theory
SDK Software Development Kit
TFMM Temporal-Function Market Making
TradFi Traditional Finance
VaR Value at Risk
wADA Wrapped Cardano
wBTC Wrapped Bitcoin
wETH Wrapped Ethereum

We claim:

1. A method comprising:
calculating, by a computing device, at least one entry of a weight vector according to at least one estimator-based rule to be applied to a liquidity pool; and
based at least in part upon the calculated at least one entry of a previous weight vector, storing, by the computing device, the at least one entry of the weight vector onto a blockchain configured to determine whether to perform an exchange of at least one asset for at least one other asset from among a pre-defined pool of other assets.

2. The method of claim 1, wherein the at least one estimator-based rule comprises at least one of the following:
gradient of a blockchain oracle or related function provided on a blockchain at a pre-selected temporal scale;
variance of the blockchain oracle or related function provided on the blockchain at the pre-selected temporal scale;
covariance of the blockchain oracle or related function provided on the blockchain at the pre-selected temporal scale;
precision of the blockchain oracle or related function provided on the blockchain at the pre-selected temporal scale; and
moving average of the blockchain oracle or related function provided on the blockchain at the pre-selected temporal scale.

3. The method of claim 1, wherein the at least one estimator-based rule comprises at least one of the following:
momentum;
anti-momentum;
minimum variance; and
power channel.

4. The method of claim 1, wherein the at least one estimator-based rule comprises at least one automated market maker (AMM) rule.

5. The method of claim 1, wherein the at least one entry of a calculated weight vector comprises at least one automated market maker (AMM) weight vector of a pool.

6. A method comprising:
calculating, by a computing device, at least one entry of a weight vector according to at least one estimator-based rule;
applying, by a computing device, at least one maximal extractable value (MEV) protection to a value of the at least one entry of the weight vector; and
storing, by a computing device, at least one entry of a weight vector configured to be applied to a particular liquidity pool.

7. The method of claim 6, where applying the at least one MEV protection further comprises at least one limit configured to limit at least one of:
restricting, by a computing device, the entries in the weight vector to take values that are within a pre-specified range;
restricting, by a computing device, the maximum allowed change of the entries of the weight vector from one block index to a future block index;
depositing, by a computing device, holdings to the liquidity pool, including as part of a trade; and
withdrawing, by a computing device, holdings from the liquidity pool, including as part of a trade.

8. The method of claim 6, further comprising:
initializing, by a computing device, a weight vector update process after a predetermined period of time elapses since a previous application of the weight vector update process; and
receiving, by a computing device, at least one oracle data feed on a blockchain.

9. A method comprising:
calculating, by a computing device, at least one entry of the block-specific weight vector configured for a trading function for a given block index;
in response to a withdrawal request if one is made, calculating, by a computing device, at least one withdrawal fee based upon a predefined fee structure;
updating, by the computing device, at least one reserve;
checking, by the computing device, for at least one invariant proportional and/or performing an invariant check;
checking, by the computing device, for at least one net change of pool reserves for at least one trades configured for maximum extract value protection;
checking, by the computing device, for at least one liquidity provider holding, whether the transaction comprises a withdrawal request or a deposit request as part of a composite pool trade comprising at least one of withdrawal, deposits, and trades of liquidity provider tokens as constituent steps; and
upon determining that all requirements are satisfied, committing, by the computing device, at least one transaction to the blockchain.

10. The method of claim 9, further comprising:
determining, by a computing device, at least one signal constructed utilizing at least one of gradient, covariance, precision, or moving average calculated using at least one estimator; and
transmitting, by a computing device, the determined at least one signal to a market as a continuous feed, stochastic feed, or blockchain oracle.

11. The method of claim 10, wherein the at least one estimator comprises at least one of the following:
gradient of a blockchain oracle or related function provided on a blockchain at a pre-selected temporal scale;
variance of the blockchain oracle or related function provided on the blockchain at the pre-selected temporal scale;
covariance of the blockchain oracle or related function provided on the blockchain at the pre-selected temporal scale;
precision of the blockchain oracle or related function provided on the blockchain at the pre-selected temporal scale; and
moving average of the blockchain oracle or related function provided on the blockchain at the pre-selected temporal scale.

12. The method of claim 9, further comprising:
calculating, by the computing device, at least one component of automated market maker trading function based upon at least one non-linear technique for a plurality of ledger blocks.

13. The method of claim 9, further comprising:
performing, by the computing device, at least one compliance check.
